(19) United States
(12) Patent Application Publication
(10) Pub. No.: US 2024/0375807 A1
(43) Pub. Date: Nov. 14, 2024

(54) TRANSPORT APPARATUS AND TRANSPORT SYSTEM FOR CONTAINERS, AND PROCESSING MACHINE FOR PROCESSING CONTAINERS

(71) Applicant: Bausch + Stroebel SE + Co. KG, Ilshofen (DE)

(72) Inventors: Andreas Boehmike, Ilshofen (DE); Klaus Kaiser, Ilshofen (DE); Daniel Spieler, Ilshofen (DE); Steffen Heier, Ilshofen (DE); Sebastian Faerber, Ilshofen (DE); Manuel Wallisch, Ilshofen (DE)

(21) Appl. No.: 18/781,104

(22) Filed: Jul. 23, 2024

Related U.S. Application Data
(63) Continuation of application No. PCT/EP2023/051787, filed on Jan. 25, 2023.

(30) Foreign Application Priority Data
Jan. 28, 2022 (DE) 10 2022 102 079.7

(51) Int. Cl. B65B 43/42; B65G 35/06; B65G 47/08

(52) U.S. Cl. CPC B65B 43/42; B65G 35/06; B65G 47/08; B65G 2201/0235

(57) ABSTRACT

A transport apparatus for pharmaceutical containers includes a drive body, a drive device actuatable by a control device for implementing a timed movement of the drive body, and holding elements operatively connected to the drive body. Each holding body has at least one container receiving area for receiving a respective container. The transport apparatus also has first and second transfer regions for containers in the circulating direction of the drive body, and a deflecting region between the transfer regions in the running direction of the drive body. The first transfer region has a receiving region, and the second transfer region forms a hand-over region. The first transfer region and/or the second transfer region extends in a linear manner with respect to the running direction of the drive body. The transport apparatus can be used with a transport system for containers and a processing machine for processing containers.

### CROSS-REFERENCE TO RELATED APPLICATIONS

This application is a continuation of International Application No. PCT/EP2023/051787, filed on Jan. 25, 2023, and claims priority to German Application No. 10 2022 102 079.7, filed on Jan. 28, 2022. The contents of International Application No. PCT/EP2023/051787 and German Application No. 10 2022 102 079.7 are incorporated by reference herein in their entireties.

### FIELD

The present disclosure relates to a transport apparatus for pharmaceutical containers in particular.

In addition, the present disclosure relates to a transport system with at least one transport apparatus.

The present disclosure furthermore relates to a processing machine for in particular processing pharmaceutical containers with a transport system.

### BACKGROUND

In such a processing machine, the containers run through different types of processing stations (which can also be referred to as processing devices), for example, from an inlet to an outlet. For example, the supplied containers are first weighed, subsequently filled, weighed again, closed, and decoupled. It is conceivable here that processing stations be combined spatially and functionally.

In the present case, the containers can in particular be pharmaceutical containers, such as vials, syringes, carpules, and/or ampoules. In the present case, “containers” can also include other types of packaging means, for example, cosmetic containers.

The transport apparatus described here is in particular part of a transport system of the processing machine and is used, for example, on the coupling side as a coupling apparatus and/or on the decoupling side as a decoupling apparatus. In a transport system, a further transport apparatus with a transport unit can, for example, be provided, which is movable back and forth linearly along a transport path extending in a straight line. Such transport apparatuses operate in a clocked manner, wherein the containers can be moved forward individually or in groups of a plurality of them. A transport apparatus of this type, in which a transport rake and a counter rake, each with “prongs,” are used, is described in DE 10 2018 213 800 A1. Between the respective prongs of the transport rake and of the counter rake, a container receptacle of variable size is formed, in which the containers, fixed to the two rakes, can be transported along the transport path.

### SUMMARY

It is an object of the present disclosure to provide a transport apparatus, a transport system, and a method which in particular enable container transport for clocked hand-over.

This object is achieved by a transport apparatus in accordance with the present disclosure for pharmaceutical containers in particular, comprising an in particular closed circulating drive body, a drive device, controllable by a control device, for implementing a clocked movement of the drive body, multiple holding elements, which are operatively connected to the drive body and each of which has at least one container receptacle for taking over a respective container, wherein, in the circulating direction of the drive body, the transport apparatus comprises a first transfer region for containers, a second transfer region for containers, and a deflection region arranged between them in the running direction of the drive body, wherein the first transfer region forms a take-over region and the second transfer region forms a hand-over region, wherein the first transfer region and/or the second transfer region is designed to extend in a straight line in relation to the running direction of the drive body.

The transport apparatus in accordance with the present disclosure comprises at least two transfer regions. Containers to be transported can be taken over by the transport apparatus at a transfer region forming a take-over region. The driven drive body can transport the containers to the further transfer region forming a hand-over region. At the hand-over region, the containers can be released again from the transport apparatus and supplied to further processing. The movement of the circulating drive body can take place in a clocked manner.

This, in particular, allows synchronizing the transport of the containers with the movement of a transport apparatus operating in a clocked manner, to which the containers are handed over or from which the containers are taken over. The transport apparatus in accordance with the present disclosure is therefore, in particular, suitable for use in a transport system with a transport apparatus that operates in a clocked manner and is moved in a straight line, as described, for example, in DE 10 2018 213 800 A1 or in the patent application with application number DE 10 2022 102 058.4 of the same applicant with the same filing date of Jan. 28, 2022, and the title, “Transport System, Device with a Transport System and Method”. The disclosures of these two patent applications are incorporated in their entirety into the present patent application. For reliable hand-over or take-over, at least one transfer region is designed to extend in a straight line in the running direction of the drive body so that the containers are, for example, arranged parallel to the further transport apparatus operating in a clocked manner and can preferably be reliably taken over or handed over by said further transport apparatus. In practice, it has been found that a compact design of the transport apparatus in accordance with the present disclosure, and thus preferably also of the transport system and of the processing machine, can be achieved through the at least one deflection region between the transfer regions.

The control device can be an independent control device of the transport apparatus. Alternatively or additionally, a control device of the transport system may be provided.

The holding elements can be coupled directly or indirectly to the drive body.

The transport apparatus can comprise a support device, for example, in the form of a frame or framework. The transport apparatus can, for example, be positioned or positionable on a frame or substructure of the transport system and/or the processing machine.

The first and the second transfer regions can advantageously be designed to extend in a straight line in relation to the running direction.

It can be provided that at least one of the transfer regions be designed to be curved in relation to the running direction of the drive body.

It can be advantageous if the transport apparatus comprises a first side, on which the first transfer region is arranged, and a second side, on which the second transfer region is arranged, wherein the sides are aligned at an angle to one another. Based upon a plan view of the transport apparatus, the transfer regions are arranged on sides aligned at an angle to one another, wherein the deflection region is arranged between them.

The angle can, for example, be approximately 30° to 120°, preferably approximately 45° to 90°.

For example, the angle is 90° or substantially 90°. In a different embodiment, the angle can, for example, be 45° or substantially 45°.

Based upon a plan view, the transport apparatus can, for example, comprise a third side, which is aligned at an angle to at least one of the two sides.

It can prove advantageous if the transport apparatus comprises a third transfer region for containers, which is connected to the first transfer region and to the second transfer region in the running direction of the drive body via at least one deflection region in each case. In this case, precisely one third transfer region can in particular be provided.

The third transfer region can, for example, form a take-over region or a hand-over region, where containers are taken over or handed over by the transport apparatus.

The third transfer region can be designed to extend in a straight line or be curved in relation to the running direction of the drive body.

In particular, it can be provided that only one transfer region be designed to extend in a straight line.

In a preferred embodiment, the transport apparatus can comprise a third side, on which the third transfer region is preferably arranged, wherein the third side is aligned at an angle relative to the first side and/or to the second side.

The angle can, for example, be approximately 30° to 120°, preferably approximately 45° to 90°.

In a preferred embodiment, the respective angle can, for example, be 45° or substantially 45°, alternatively, 90° or substantially 90°.

In a preferred embodiment, the transport apparatus can form a coupling apparatus, wherein containers can be coupled into at least one take-over region via at least one coupling unit and can be decoupled via the hand-over region to a further transport apparatus. The coupling apparatus can thus in particular be arranged on the inlet side of a transport system.

It can be advantageous if the transport apparatus forms a decoupling apparatus, wherein containers can be coupled via the take-over region from a further transport apparatus and can be decoupled via at least one hand-over region to at least one decoupling unit. The transport apparatus can in particular be arranged on the outlet side of a transport system.

It can be provided in particular that the transport apparatus be configured to be passive for taking over and/or handing over containers, wherein a take-over by an active coupling unit, a hand-over to an active decoupling unit, and/or a take-over and/or hand-over by an active further transport apparatus take place.

A preferred embodiment of the present disclosure is characterized in that the transport apparatus has a substantially triangular contour in plan view. In this case, the contour is, for example, formed by a housing of the transport apparatus. The transport apparatus can, for example, comprise the three aforementioned sides (first side, second side, third side), which form the triangular contour. The corners of the triangular contour on which a deflection region can be formed in each case are rounded, for example.

In plan view, the transport apparatus can, for example, have a contour in the form of an isosceles or equilateral triangle and/or in the form of a right triangle. A preferred embodiment of the transport apparatus has, for example, a contour of an isosceles right triangle in plan view, wherein transfer regions are arranged at least on two sides. These sides can in particular be the legs of the triangle aligned at a right angle to one another. A further transfer region can optionally be arranged on the third side, the hypotenuse.

It can be provided that the transport apparatus have a different type of contour in plan view, e.g., semicircular, in the form of a “straight” oval (two, mutually opposite straight regions which are connected via curved deflection regions), quadrangular (in particular, rectangular or square), trapezoidal with rounded deflection regions which connect the sides of the trapezoid, etc.

It can be provided that the transport apparatus be free of processing stations for the containers so that, in particular, no processing station is arranged at the transport apparatus.

A preferred embodiment of the present disclosure, for example, provides that the transport apparatus comprises a housing, which encloses an interior, and drive elements coupled to the drive body, wherein the drive body and the drive elements are arranged in the interior. The transport apparatus advantageously comprises transport elements connected to the holding elements or comprising or forming the holding elements and assigned to the drive elements. The transport elements can be arranged on an outer side, facing away from the interior, of the housing, and can be movable on the outer side via the movement of the drive bodies. The transport elements can be coupled to the drive elements directly, in particular, physically, or indirectly, for example, via a distance force. A movement of the drive body results in the movement of the drive elements and of the transport elements assigned thereto. The holding elements and thus the containers are thereby moved.

Preferably, the interior is sealed via the housing in a pharmaceutically compliant manner relative to the outer side. For example, the transport apparatus is used in an atmosphere of an insulator device, wherein contamination of the atmosphere can be avoided by sealing the housing.

The drive elements are preferably contactlessly coupled to the transport elements. In particular, a magnetic coupling of the drive elements to the transport elements is preferred here. The drive elements and the transport elements are advantageously arranged on two sides of a housing wall that face away from one another and through which the magnetic force acts.

The drive elements and the transport elements comprise or form magnetic elements designed as Halbach arrays, for example.

The housing can, for example, comprise a circumferential side wall, wherein the transport elements are movable along the side wall in the circumferential direction of the housing. In this case, the transport elements are moved along the outer circumference of the housing, for example. The drive body and the drive elements are, for example, moved along the inner circumference of the drive body.

It can be provided that the drive elements comprise rollers for rolling on a side, facing the interior, of a housing wall, in particular, the side wall.

Alternatively or additionally, the transport elements can comprise rollers for rolling on a side, facing away from the interior, of the housing wall, in particular, the side wall.

The rollers can, for example, comprise transport and/or guide rollers.

Groove-shaped recesses for aligning the rollers can be arranged on the inside and/or outside of the housing wall in order to ensure precise positioning of the drive elements and/or of the transport elements.

It can be advantageous if the housing comprises a top wall and if the holding elements or at least the holding portions that receive containers of the holding elements are arranged above the top wall in relation to the direction of gravity. In intended use, the transport apparatus is, for example, positioned on a frame or substructure such that the top wall is arranged on the upper side, and the holding elements or holding portions are positioned above the top wall. In this case, the containers can preferably be arranged above the top wall.

It can be provided that the holding elements each comprise at least one container receptacle for receiving a container, which container receptacle is arranged above the drive body in the direction of gravity.

The holding elements are preferably detachably connectable to the transport elements. This, for example, affords the possibility of using different types of holding elements with the same transport elements, depending upon the containers to be transported.

For example, the transport apparatus comprises format sets of different types of holding elements, wherein the holding elements of a format set differ from the holding elements of a different format set in at least one container-specific property, wherein the holding elements of a format set are selectively usable with the transport apparatus, in particular, for connection to the transport elements. The holding elements are, for example, provided for containers of different sizes and/or different container types, wherein the holding elements can preferably cover particular format ranges with regard to size and/or container type.

Holding elements can in particular be provided for vials, syringes, carpules, and/or ampoules.

The transport elements project, for example, beyond the top wall in the height direction, wherein the holding elements are arranged above the top wall and are connected to the transport elements.

It can be provided that the holding elements be arranged laterally next to the side wall of the housing so that the container receptacles are, for example, arranged radially outside with respect to the side wall.

The holding elements, for example, comprise holding portions which receive the containers and are arranged offset radially inwards relative to a side wall of the housing. As a result, centrifugal forces on the containers can be reduced, and a more reliable transport of the containers can be made possible.

A respective container receptacle preferably defines an axis, which runs in a plane defined by the drive body, preferably along the entire extension of the drive body. When the container has been received as intended, the axis of the container receptacle preferably coincides with an axis of the container. In practice, the course of the axis in the plane of the drive body, which is, for example, belt-like or strap-like, can prove to be advantageous for the transport of the containers in particular at a deflection region of the transport apparatus.

The respective container receptacle preferably comprises a recess for the positive-locking and/or force-locking reception of a container and/or a receptacle bottom on which a container is settable.

The recess advantageously comprises an insertion opening for the container in the direction of an outer side of the transport apparatus, for example, radially outwards. Via the insertion opening, the container can be inserted into the container receptacle and removed therefrom so that a transfer of the containers in the lateral direction is made possible.

It may be provided that the holding elements comprise two or more container receptacles for receiving two or more containers, which container receptacles are, for example, arranged one behind the other in the running direction of the drive body.

It can be provided that the drive body be configured to have multiple members or multiple segments. In this case, a chain, for example, may be used.

In a preferred embodiment of the present disclosure, the drive body is a belt or comprises a belt, wherein the drive device comprises a drive roller for the belt and a drive motor for driving the drive roller.

Regarded as a belt in the present case is, in particular, a drive body that is configured to be flat and has a significantly smaller extension in one spatial direction than in a further spatial direction aligned transversely and in particular perpendicularly thereto, wherein the drive body extends longitudinally in a third spatial direction transverse and in particular perpendicular to the aforementioned spatial directions, wherein the third spatial direction defines the running direction. The belt may also be referred to as a strap or band. The belt can be a toothed belt, wherein the drive roller can be a toothed roller.

The drive device can comprise at least one non-driven deflection roller for the belt and/or at least one tensioning roller for adjusting the belt tension. A deflection roller can be designed as a tensioning roller.

In the case of a triangular shape of the transport apparatus, as mentioned above, a drive roller for the drive body, a deflection roller, and a further deflection roller in the form of a tensioning roller are provided, for example.

In the case of a shape of the transport apparatus with a “straight oval,” as mentioned above, a drive roller and a deflection roller in the form of a tensioning roller are provided, for example.

In a preferred embodiment of the present disclosure, the transport apparatus comprises more than two drive bodies, each of which is assigned multiple holding elements, wherein in particular three drive bodies can be provided.

Via the plurality of drive bodies, a continuous take-over of the containers during coupling via a coupling wheel or a continuous hand-over of the containers during decoupling via a decoupling wheel can preferably be made possible, in combination with the possibility of a clocked transfer to a transport apparatus operating in a clocked manner.

The respective drive body can be coupled to drive elements, which in turn can be operatively connected to transport elements, as explained above. The drive elements are preferably configured such that identical transport elements can also be used even with different drive bodies. Preferably, the drive elements that are used with different drive bodies are configured to be identical and functionally identical, and differ only in the manner of coupling to the respective drive body.

The transport apparatus advantageously comprises respective drive devices assigned to the drive bodies, wherein, for driving the drive bodies, the drive devices are preferably controllable independently of one another by the control device. This makes particularly versatile operation of the transport apparatus possible. The different drive bodies can, for example, be moved at different speeds depending upon their respective position in the running direction.

The drive bodies preferably define a common plane, wherein they are, for example, configured as belts.

In a height direction of the transport apparatus, in particular, in the direction of gravity, the drive bodies are preferably arranged one above the other. It is preferably provided that the holding elements which are assigned to different drive bodies be arranged at an identical position in the height direction and/or in the radial direction.

The drive device is controllable for moving the drive body with regard to at least one of the following:
distance-time profile of the drive body, in particular, with regard to a clocked transport of the containers;
time of movement of the drive body;
standing time of the drive body without movement;
speed of the drive body;
acceleration of the drive body;
stopping the movement of the drive body at the take-over region and/or at the hand-over region;
the drive body passing the take-over region and/or the hand-over region without stopping;
movement of a drive body and/or drive element depending upon the movement of a further drive body and/or drive element.

The above possibilities of controlling the drive body can be specified and/or specifiable. As already mentioned, two or more drive bodies can preferably be controlled independently of one another.

In a preferred embodiment of the present disclosure, the control of the drive device by the control device is changeable during operation of the transport apparatus, in particular, depending upon a signal suppliable or supplied to the control device. For example, a sensor device or a processing station can be provided at the transport system in order to provide a signal to the control device to change the transport of the containers during ongoing operation by means of at least one of the control options. Conceivable in this case is in particular a deceleration in the event of a fault and/or in the case of a processing station operating at a slower speed, or, alternatively, an acceleration when the processing rate can be increased.

As already mentioned, the present disclosure also relates to a transport system.

A transport system in accordance with the present disclosure, which achieves the object mentioned at the outset, comprises a transport apparatus of the type described above and at least one coupling unit at at least one take-over region, wherein the containers are configured to be taken over by the holding elements from the coupling unit supplying said containers. In particular, the transport apparatus forms the coupling apparatus of the transport system. The take-over can take place passively or actively.

The at least one coupling unit can, for example, comprise a coupling wheel for the containers, which are taken over as volume goods (bulk) by the transport apparatus while rotating the coupling wheel and moving the drive body at a preferably constant speed. For example, a turntable for bulk goods of containers is provided, from which the containers are continuously supplied directly or indirectly to the coupling wheel. The containers are coupled into the moving holding elements via the coupling wheel.

Alternatively or additionally, it can be provided that the at least one coupling unit comprise a robot for receiving containers, which are in particular arranged in a common carrier (for example, a nest) and are suppliable to the holding elements for take-over.

The robot, e.g., an articulated arm robot, can preferably remove a plurality of containers in a clocked manner from the carrier and insert them into container receptacles of the container elements. The holding elements may be unmoved or moved during the take-over.

A further transport system in accordance with the present disclosure, which achieves the object mentioned at the outset, comprises a transport apparatus of the type described above and at least one decoupling unit at at least one hand-over region, wherein the containers are configured to be handed over by the holding elements to the at least one decoupling unit discharging said containers.

The transport apparatus can in particular form a decoupling apparatus of the transport system, wherein the containers can be supplied through the hand-over to further processing, for example, inserting into a carrier or storing. The transfer can take place passively or actively.

In a preferred embodiment of the present disclosure, the at least one decoupling unit can comprise a decoupling wheel for the containers, which are handed over as bulk goods by the transport apparatus while rotating the decoupling wheel and moving the drive body at an in particular constant speed. The decoupling wheel can continuously remove the containers from the container receptacles and supply them to further processing.

Alternatively or additionally, the at least one decoupling unit can comprise a robot, to which the containers are configured to be handed over in particular for insertion into a common carrier. For example, the robot takes over the containers in a clocked manner from the container receptacles. In this case, the holding elements can be unmoved or moved.

The object mentioned above is also achieved by a transport system of the present disclosure, with at least one transport apparatus of the type described above or a transport system of the type described above, and a further transport apparatus which comprises a transport path, which extends in a straight line and defines a transport direction, and at least one transport unit which is arranged at the transport path so as to be movable along the transport direction, wherein the transport unit is movable in a clocked manner under the control of the control unit, wherein the transport path is in particular aligned parallel to the extension direction of the at least one transport region extending in a straight line, wherein the clocked movements of the drive body and of the transport unit are synchronizable such that at least a portion of the container receptacles of the holding elements and corresponding container receptacles of the transport unit can be aligned relative to one another along the transport direction, and wherein at least a portion of the containers are transferable from the transport apparatus to the transport unit or vice versa.

The advantages that can be achieved with the transport apparatus in accordance with the present disclosure can also be achieved in the respective transport system in accordance with the present disclosure. Reference is made to the above explanations. Advantageous embodiments of transport systems in accordance with the present disclosure result from advantageous embodiments of the transport apparatus in accordance with the present disclosure. Reference is made to the above statements.

In the last-mentioned transport system in accordance with the present disclosure, the transport apparatus is, for example, arranged on the inlet side. Containers are taken over by said transport apparatus and handed over to the further transport apparatus, wherein, preferably, the transport unit thereof can be configured to be active, and the transport apparatus can be configured to be passive. The respective clocked movement of the holding elements via the drive body on the one hand and the transport unit on the other is synchronized such that the container receptacles can be aligned relative to one another. For example, the container receptacles are positioned opposite one another or brought into alignment with one another. This can in particular include the case in which the container receptacles are aligned such that the containers can be taken over directly by the transport unit.

The same can apply to the outlet side of the transport system, wherein the containers are supplied by the further transport apparatus and taken over by the transport apparatus in accordance with the present disclosure.

The further transport apparatus can be configured as described in DE 10 2018 213 800 A1 or in the patent application with application number DE 10 2022 102 058.4 of the same applicant with the same filing date of Jan. 28, 2022, and the title, “Transport System, Device with a Transport System and Method”. In said patent application, the transport units are referred to as transport devices, which can be moved back and forth along the transport path.

The number of respective container receptacles (locations) of the holding elements in total can, for example, be the number of container receptacles (locations) of the transport unit. Advantageously, all container receptacles of the holding elements are occupied, just like all container receptacles of the transport unit.

However, it is conceivable that only a portion of the containers occupying the container receptacles of the holding elements be transferred to the transport unit or vice versa. The present disclosure preferably allows specifying a number of containers (number of locations) to be handed over during the transfer of containers between the transport apparatus and the transport unit. This can be implemented with suitable control of the transport apparatus and/or the further transport apparatus. Preferably, an adaptation can in this case take place during ongoing operation of the transport system. It can be advantageous if the number of container receptacles of the holding elements that are assigned to a drive body matches the number of container receptacles of the at least one transport unit.

The transport unit preferably comprises holding parts, movable relative to one another along the transport direction, and gripping elements held thereon, wherein a gripping element on one of the holding parts, together with a gripping element on the other holding part, defines an expandable container receptacle in each case, and wherein the holding parts are movable transversely and in particular perpendicularly to the transport direction in a transfer direction. The holding parts with the respective gripping elements form, for example, so-called rakes and counter rakes, as described in DE 10 2018 213 800 A1 or DE 10 2022 102 058.4. By moving the holding parts relative to one another, the container receptacle can be expanded for transferring the containers. The container receptacle is reduced by relative movement of the holding parts in the opposite direction, and the container is held at the gripping elements. A movement transverse and in particular perpendicular to the transport direction makes it possible, for example, to take over the containers from the holding elements or to hand them over to said holding elements.

The movement of the holding parts can take place, for example, as described in the patent applications mentioned above. For example, transport elements which are coupled to the holding parts via coupling elements are arranged at the transport path. In this case, two transport elements can be assigned to each holding part, wherein a transport element, the coupling elements, and the holding part form an articulated parallelogram in each case. Depending upon the movement of the transport elements relative to one another, the container receptacles can be expanded or reduced, and the holding parts can be moved forwards or backwards in the transfer direction. Reference is made to the aforementioned sources of disclosure.

For transferring the containers between the transport apparatus and the transport unit, the gripping elements are, for example, transferable along the transfer direction from a distant position to a close position in order to bring the container receptacles of the holding elements into alignment with the container receptacles of the transport unit. In this case, for hand-over to the transport unit, the containers are preferably gripped by the gripping elements and are removed from the container receptacles of the holding elements by said gripping elements. Alternatively, for take-over from the transport unit, the containers can be inserted by the gripping elements into the container receptacles of the holding elements.

It can be provided that, during the transfer of the containers, the drive body be non-driven and the transport unit not be moved along the transport direction, wherein the containers are transferred between the distant position and the close position and back by moving the gripping elements.

It can be provided that, during the transfer of the containers, the holding elements be moved synchronously and in particular parallel to one another via the drive body and the transport unit, wherein the gripping elements assume the close position. For example, the gripping elements are transferred to the close position in order to bring the container receptacles of the transport unit and of the holding elements into alignment. The gripping elements can grip the containers in that the holding parts are moved relative to one another, and the gripping elements are applied to the containers. Through the synchronous movement, the containers are transported away by the transport unit, wherein they are simultaneously removed from the container receptacles of the holding elements, which are moved further via the drive body and are moved away from the transport unit at a deflection region.

As mentioned at the outset, the present disclosure also relates to a processing machine.

A processing machine in accordance with the present disclosure, which achieves the object mentioned at the outset, for processing containers comprises a transport system of the type described above and at least one processing station for the containers, which processing station is arranged at the transport path and is suppliable with the containers by means of the at least one transport unit. The at least one processing station comprises at least one of the following:
a weighing station;
a filling station;
a closing station;
a monitoring station;
a parking station; and
a holding station.

It is conceivable that two or more stations be combined, spatially and functionally integrated, in a processing station.

The advantages achievable with the transport apparatus in accordance with the present disclosure and the transport system in accordance with the present disclosure can also be achieved in the processing machine in accordance with the present disclosure. Advantageous embodiments of the same result from advantageous embodiments of the transport apparatus and of the transport system. Reference is made to the above explanations.

### BRIEF DESCRIPTION OF THE DRAWINGS

The following description of preferred embodiments of the present disclosure serves in conjunction with the drawings to explain the present disclosure in more detail. In the figures:

FIG. 1 is a schematic representation of a processing machine in accordance with the present disclosure, comprising a transport system in accordance with the present disclosure and two transport apparatuses in accordance with the present disclosure;

FIG. 2 is an enlarged detail view of detail A and of further components of the processing machine, wherein a transport apparatus is shown in plan view;

FIG. 3 is a perspectival view of the transport apparatus in an exploded view;

FIG. 4 is a perspectival exploded view of components of a drive system of the transport apparatus;

FIG. 5 is a (partial) sectional view of the transport apparatus along line 5-5 in FIG. 2;

FIG. 6 is a detail view of a transport apparatus of the processing machine of FIG. 1 in a perspectival view showing transport units in different positions;

FIG. 7 is a representation similar to FIG. 2 in a perspectival view with a few components not shown, showing the hand-over of containers from the transport apparatus to a transport unit;

FIGS. 8 and 9 show preferred embodiments of the transport apparatus in accordance with the present disclosure;

FIG. 10 is a perspectival partial representation of a transport unit of the transport system in accordance with the present disclosure; and

FIG. 11 is a perspectival representation of a holding element of a transport apparatus in accordance with the present disclosure.

### DETAILED DESCRIPTION

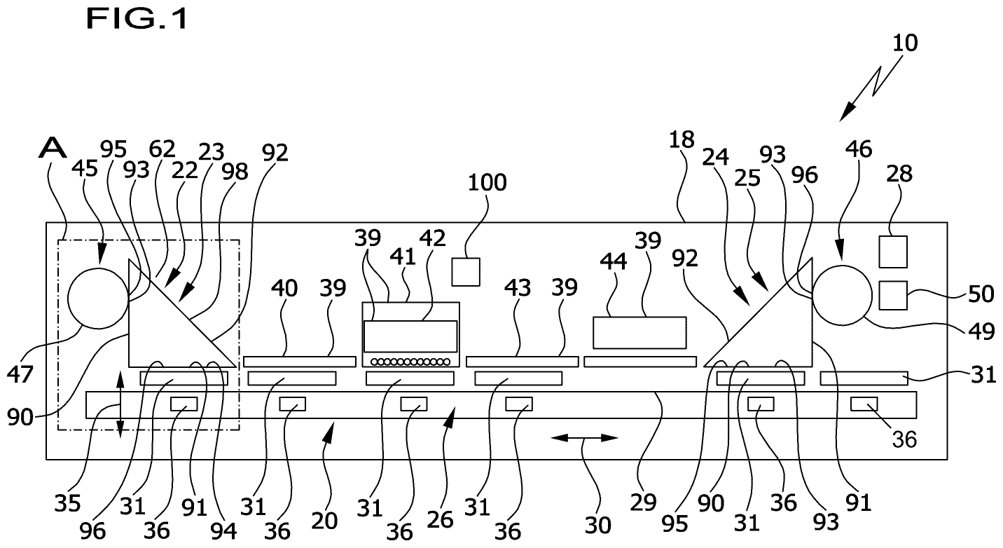

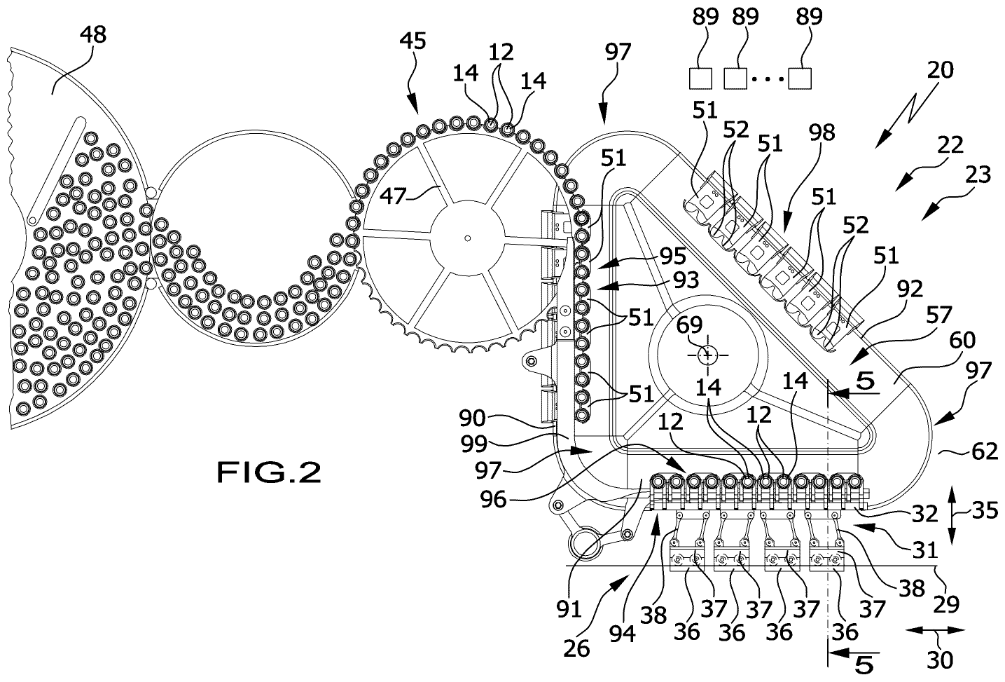

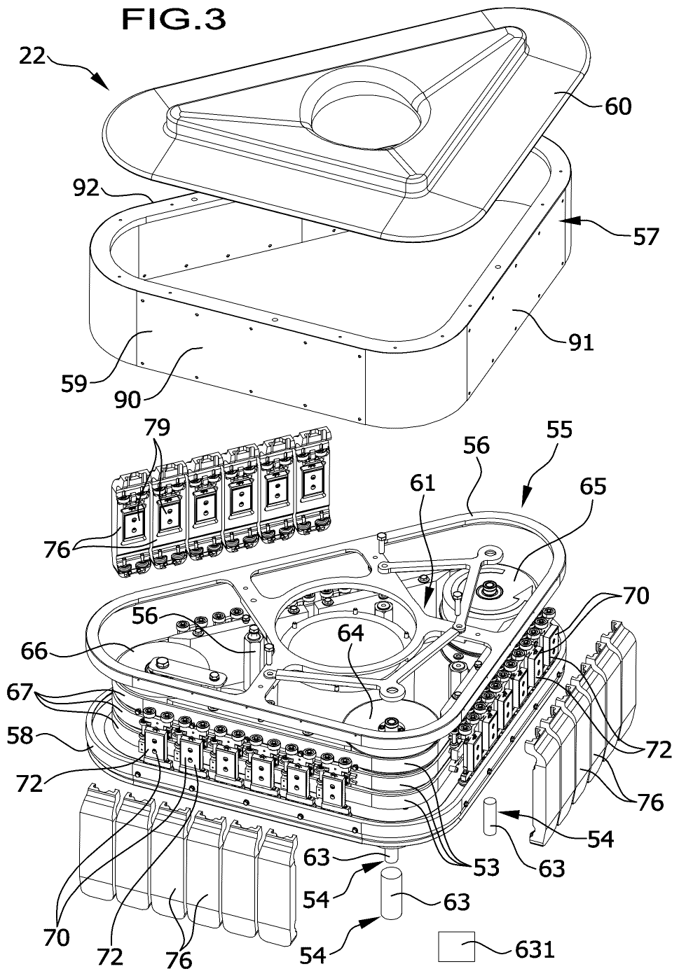

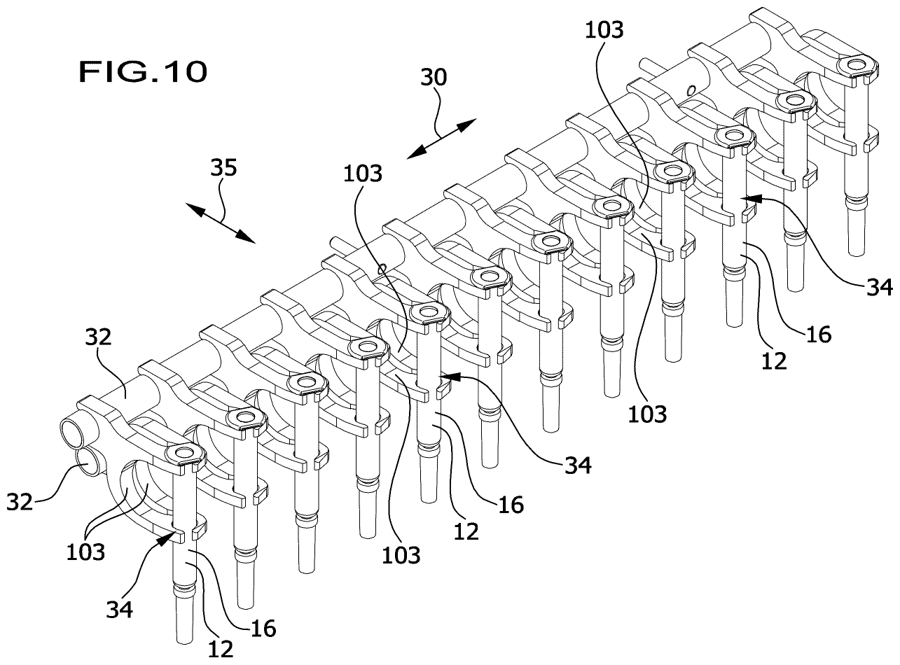

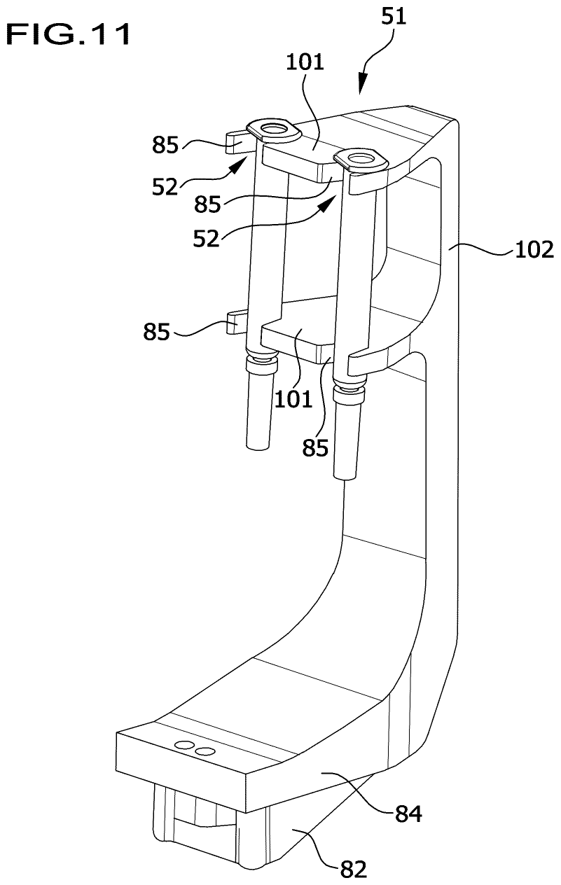

FIG. 1 shows, in a schematic representation, an advantageous embodiment of a processing machine in accordance with the present disclosure for processing containers 12, which is denoted as a whole by reference numeral 10. As examples of the containers 12, the drawing shows vials 14 in FIGS. 2, 3 and 6 to 9 as well as syringes 16 in FIGS. 10 and 11.

The processing machine 10 comprises a frame 18 on which a transport system 20 is arranged. The frame 18 can be covered by an insulator device (not shown in the drawing) in order to provide a specified atmosphere. This is, for example, an atmosphere for the purpose of decontamination, for example, by means of H₂O₂.

The transport system 20 in the present case is an embodiment in accordance with the present disclosure of a transport system in accordance with the present disclosure.

The transport system 20 comprises a transport apparatus 22, which forms a coupling apparatus 23, and a transport apparatus 24 which forms a decoupling apparatus 25.

The transport apparatuses 22, 24 are preferred embodiments of the transport apparatus in accordance with the present disclosure.

The further explanation essentially discusses the transport apparatus 22. The transport apparatuses 22, 24 are designed to be symmetrical to one another and function in a symmetrical manner, wherein the transport apparatus 22 is arranged on the inlet side of a further transport apparatus 26 of the transport system 20, and the transport apparatus 24 is arranged on the outlet side of the further transport apparatus 26.

The explanations of the transport apparatus 22 apply, due to the configuration, in a corresponding manner to the transport apparatus 24, with the proviso that a take-over region of the transport apparatus 22 corresponds to a hand-over region in the transport apparatus 24, and a hand-over region in the transport apparatus 22 corresponds to a take-over region in the transport apparatus 24.

The processing machine 10 comprises a control device 28 for controlling the operation. All components of the processing machine 10 are preferably controlled in this case. It can be provided that individual components comprise an independent control device 28.

The (further) transport apparatus 26 is preferably constructed as described in the patent application with DE 10 2022 102 058.4 of the same applicant. The transport apparatus 26 comprises a transport path 29, which extends in a straight line and defines a straight transport direction 30.

The transport apparatus 26 comprises at least one transport unit 31 movable along the transport path 29 along the transport direction 30. In the present case, six transport units 31 are provided, wherein their numbers could also be different, and which are preferably configured identically. The containers 12 can be transported via the at least one transport unit 31 from the inlet of the transport apparatus 26 to the outlet thereof.

The structure and the functionality of the transport apparatus 26 are explained below. For supplementary explanation, reference is made to the above patent application and to DE 10 2018 213 800 A1.

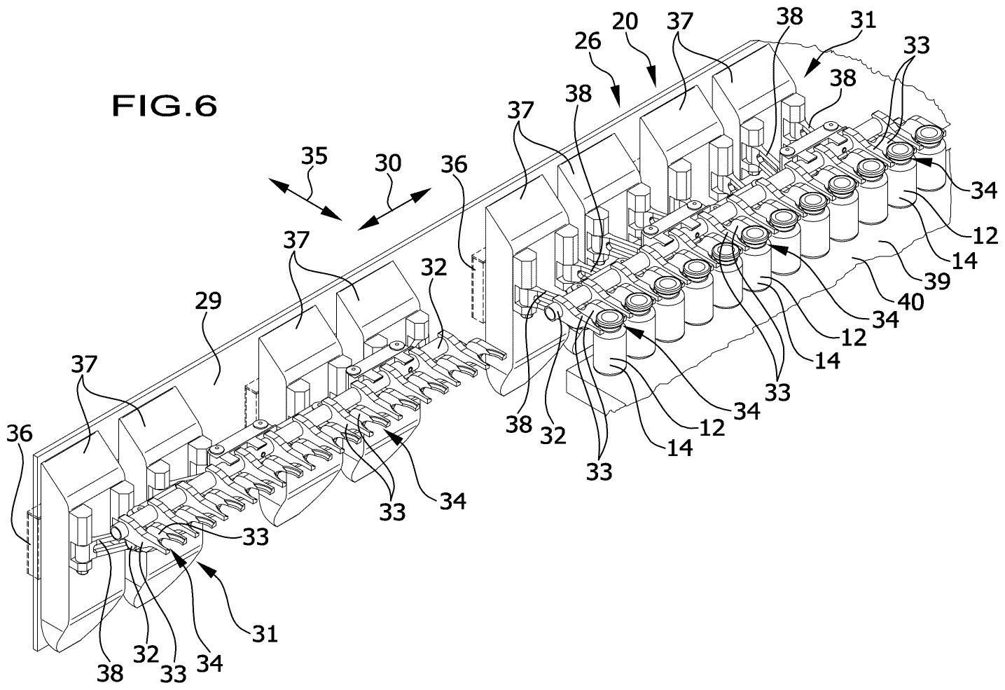

As can be seen in particular in FIGS. 2 and 6, the transport unit 31 in the present example comprises two, longitudinally extending holding parts 32. In the present case, multiple gripping elements 33, which are, for example, configured to be finger-shaped, are fixed to each holding part 32.

A container receptacle 34 for a container 12 is in each case formed between a gripping element 33 of a holding part 32 and a gripping element 33 of a further holding part 32.

The holding parts 32 are movable relative to one another along the transport direction 30. This provides the possibility of expanding the container receptacle 34 for receiving a container 12 by moving the gripping elements 33 away from one another. Conversely, the gripping elements 33 can be moved closer to one another by moving the holding parts 32. This provides the possibility of applying the gripping elements 33 to the container 12 and holding the latter in the container receptacle 34.

For moving the holding parts 32 relative to one another and in a transfer direction 35 which is configured to be transverse and, in the present case, in particular perpendicular to the transport direction 30, the transport unit 31 comprises drive elements 36, transport elements 37, and coupling elements 38.

The drive elements 36 are displaceable along the transport path 29 in the transport direction 30, in particular, via a magnetic coupling to the transport path. The drive elements 36 are magnetically coupled to a respective transport element 37 in order to also move the latter along the transport direction 30.

The transport elements 37 are coupled to the holding part 32 via coupling elements 38, forming a respective articulated parallelogram.

Depending upon the movement of the drive elements 36, the holding parts 32 along the transport direction 30 can assume different positions along the transport direction 30 and different relative positions for gripping or setting down the containers 12. In addition, a movement in the transfer direction 35 is possible. In this case, there is in particular the possibility of moving the gripping elements 33 from a distant position (on the left in FIG. 6) to a close position (on the right in FIG. 6). Both in the distant position and in the close position, the containers 12 can be held or can be released for a transfer.

It is understood that the transport elements 37 could be self-moving or could be coupled directly to the transport path 29, without the drive elements 36.

The transport units 31 are movable in a clocked manner under the control of the control device 28. In particular, a distance-time profile can be specified for a respective transport unit 31. For example, there is the possibility of specifying a time of the movement, a standing time, a speed, and/or an acceleration of the transport unit 31 along the transport direction 30 and/or the transfer direction 35.

The movements of the container receptacles 34 can be designed in such a way that a superposed movement takes place, with a respective component along the transport direction 30 and along the transfer direction 35.

FIG. 1 schematically shows only one of the drive elements 36 and a placeholder for the holding parts 32 and gripping elements 33 at the transport path 29.

The processing machine 10 comprises a plurality of processing stations 39 for processing the containers 12. From the inlet to the outlet of the transport apparatus 26, the processing stations 39 in the present example comprise a set-down station 40 for the containers 12, a weighing station 41, a filling station 42 arranged thereon, a further set-down station 43, and a closing station 44.

The supplied containers 12, in particular, vials 14, are first placed on the set-down station 40, subsequently weighed unfilled at the weighing station 41 (tare weighing), filled via the filling station 42, weighed via the weighing station 41 in the filled state (gross weighing), temporarily parked at the set-down station 43, and finally closed at the closing station 44. A monitoring station can be provided. Two weighing stations 41 could be arranged before and after the filling station 42.

The transport system 20 furthermore comprises a coupling unit 45, which is upstream of the transport apparatus 22 in the feed direction, and a decoupling unit 46, which is downstream of the transport apparatus 24 in the direction of the transport away.

During operation of the processing machine 10, the containers 12 are supplied via the coupling unit 45, taken over by the transport apparatus 22, handed over by the latter to the further transport apparatus 26, processed at the processing stations 39, taken over by the transport apparatus 24, and handed over by the latter to the decoupling unit 46.

In the present case, a coupling unit 45 is designed to continuously supply volume goods (bulk) of the containers 12 and comprises a coupling wheel 47. Containers 12 originating from a turntable 48 are supplied (indirectly in the present case) to the coupling wheel 47. It is understood that the coupling unit 45 comprises at least one corresponding drive.

The decoupling unit 46 comprises a decoupling wheel 49 for taking over containers 12 from the transport apparatus 24. The continuously decoupled containers 12 are, for example, supplied to a storage 50. It is also understood here that at least one drive can be provided.

In the following, with reference in particular to FIGS. 2 to 5 and 7, the structure and the functionality of the transport apparatus 22 are discussed. The explanations in this respect apply to the transport apparatus 24 in a corresponding manner.

In the present example, the transport apparatus 22 comprises holding elements 51 with respective container receptacles 52 for the containers 12, wherein the holding elements 51 are operatively connected to a circulating closed drive body and can be moved via the drive body 53 in a circulating manner with received containers 12 or without containers 12.

In the present case, a drive body 53 is assigned six holding elements 51, each with two container receptacles 52 in the present case. The number of locations assigned to a drive body 53 is twelve. In the exemplary embodiment, this matches the number of locations of the transport unit 31, which are defined by the container receptacles thereof.

It is understood that different numbers of locations could be provided.

In the present example, three drive bodies 53 are provided, which are respectively assigned independent holding elements 51 (and the drive elements and transport elements mentioned below). With regard to the functionality, the respective ensemble of drive body 53, drive elements, transport elements, and holding elements 51 matches, so that only one ensemble will initially be discussed.

The number of drive elements, transport elements, and holding elements 51 assigned to a respective drive body 53 preferably match.

The transport apparatus 22 comprises a drive device 54 assigned to a respective drive body 53. The drive devices 54 are controllable independently of one another by the control device 28. In this case, there is in particular the possibility of moving the respective drive body 53 in a clocked manner and controlling it with regard to at least one of the following:
distance-time profile of the drive body 53, in particular, with regard to a clocked transport of the containers 12;
time of movement of the drive body 53;
standing time of the drive body 53 without movement;
speed of the drive body 53;
acceleration of the drive body 53;
stopping the movement of the drive body 53 at the take-over region and/or at the hand-over region;
the drive body 53 passing the take-over region and/or the hand-over region without stopping;
movement of a drive body 53 and/or drive element depending upon the movement of a further drive body 53 and/or drive element.

The transport apparatus 22 comprises a support device 55, which, for example, comprises structural elements 56 forming a framework. The transport apparatus 22 stands directly or indirectly on the frame 18 via the support device 55, wherein the drive devices 54 are preferably arranged partially below the frame 18.

In the present case, a housing 57 of the transport apparatus 22 is held on the support device 55. The housing 57 comprises a bottom wall 58, a circumferential side wall 59, and a top wall 60. Housing walls, in particular, the walls 58 to 60, can be designed in one or more parts.

The housing 57 encloses an interior 61, which is preferably sealed in a pharmaceutically compliant manner against an outer side 62. The containers 12 are transported on the outer side 62, for example, within the atmosphere of the insulator device.

Passage openings for the drive devices 54 are formed in the bottom wall 58. In the present case, the drive devices 54 comprise drive shafts 63, and at least one drive motor 631 in order to drive them. For example, two drive shafts 63 are arranged as a solid shaft and hollow shaft at one position, and a further drive shaft 63 is arranged at a different position therefrom. Another type of configuration of the drive device 54 is conceivable.

For the drive body 53, the drive device 54 comprises a drive roller 64, which is driven by the respective drive shaft 63. In addition, an undriven deflection roller 65 and a further deflection roller designed as a tensioning roller 66 are assigned to each drive body 53. The closed drive body 53 runs over the rollers 64 to 66.

The rollers 63, 64, and 65 and the drive shafts 63 can be held directly or indirectly on the support device 55.

The drive body 53 is configured as a belt 67, for example, as a toothed belt. In this case, the rollers 63, 64, and 65 can be toothed rollers with a corresponding toothing.

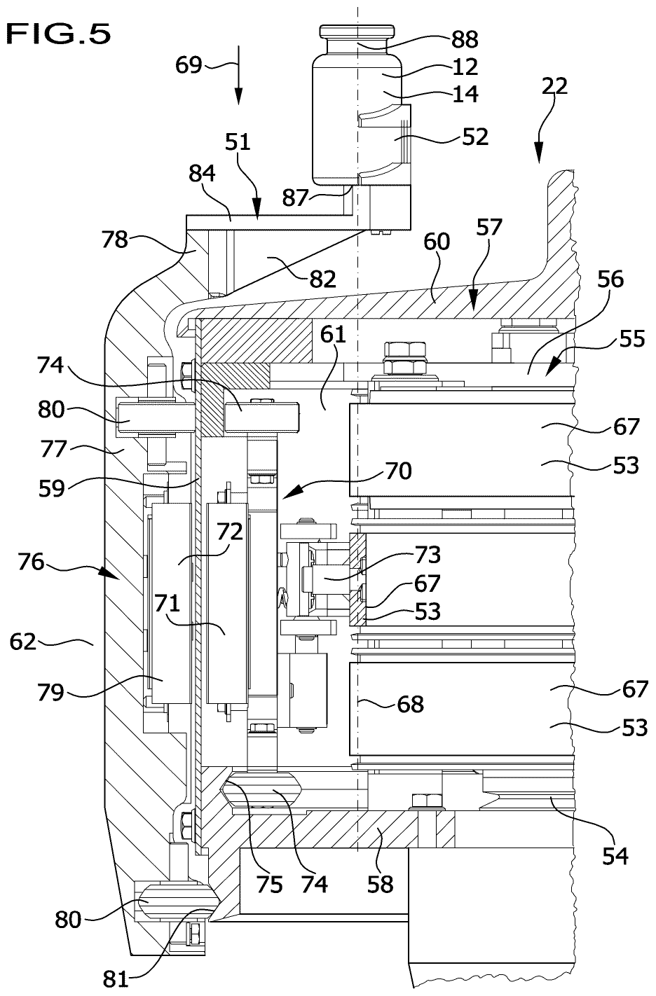

A plane 68 defined by the belt 67 extends in a height direction and in particular in the direction of gravity 69 (FIG. 5) when the transport apparatus 22 is used as intended.

The transport apparatus 22 is constructed such that the belt 67 and the rollers 64, 65, and 66 are arranged in the interior 61. During the movement, the belt 67 is moved along the inside of the side wall 59 and follows the course of the side wall 59.

The further drive bodies 53 are also belts 67. The belts 67 jointly define the plane 68. The belts 67 are arranged one above the other in the direction of gravity 69, which coincides with their height direction when the transport apparatus 22 is used as intended. In a corresponding manner, the respective rollers 63, 64, and 65 are, for example, arranged one above the other. However, in the circulating direction of the belts 67, a different type of positioning can arise in terms of the function of the rollers 63, 64, and 65 in order to enable a compact design, in particular, with regard to the drive devices 54.

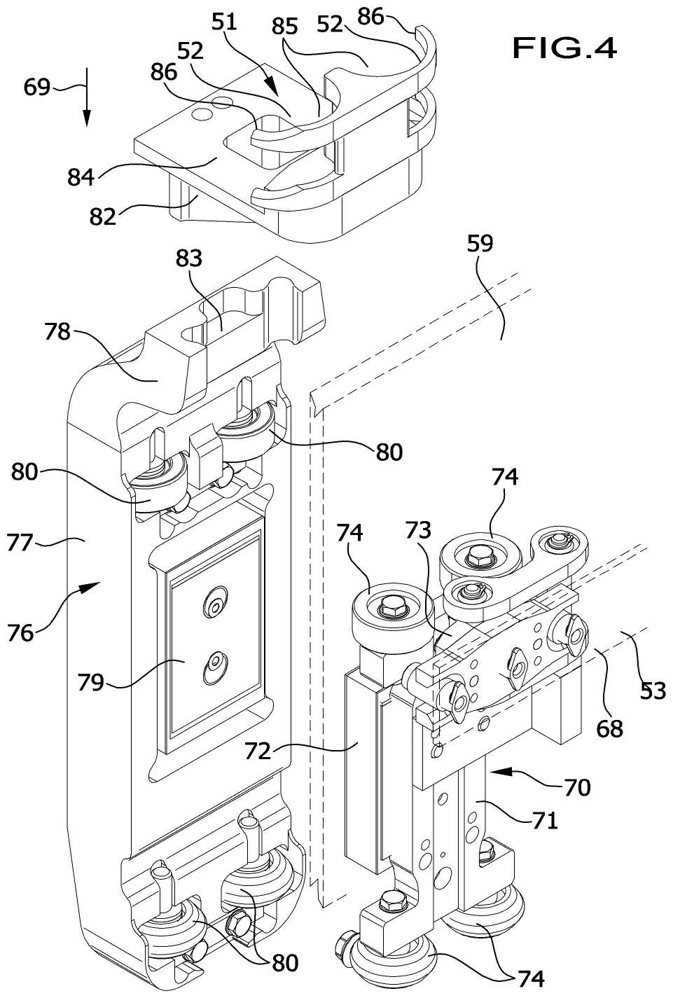

As becomes clear in particular from FIGS. 4 and 5, the drive device comprises drive elements 70 (six pieces) which are connected to the belts 67 in the interior 61. The drive element 70 comprises a substantially plate-shaped main body 71, on which a magnetic element 72 assigned to the side wall 59 is arranged.

On the side facing away from the magnetic element 72, a connecting member 73 is fixed to the main body 71, e.g., by a force-locking and/or positive-locking connection, via which connecting member the main body 71 is connected to the belt 67.

The main body 71 preferably comprises a plurality of receptacles for the connecting member 73, which can be selectively fixed to said receptacles. This, for example, allows the drive elements 70 assigned to the different drive bodies 53 to be configured identically. Depending upon the positioning of the connecting member 73 on the main body 71, the drive element 70 can be connected to the desired belt 67. Otherwise, it is conceivable that only the connecting members 73 differ from one another, and the drive elements 70 be otherwise configured identically.

Rollers 74 are arranged on the drive element. In the present case, rollers 74 are present on the underside, which engage in a groove-shaped recess 75 of a housing wall. Rollers 74 for rolling on a segment of the side wall 59 are likewise arranged on the top side.

When the belt 67 is driven, the drive elements 70 and thus in particular the magnetic elements 72 are moved on the inside along the side wall 59.

Furthermore, the transport apparatus 22 comprises transport elements 76, which are assigned to a respective drive element 70. The transport elements 76 are configured identically for all drive bodies 53. A respective transport element 76 comprises a substantially plate-shaped portion 77, which extends substantially over the height of the housing 57 in the height direction of the transport apparatus 22. On the top side, the plate-shaped portion 77 merges into a connecting portion 78, which points radially inwards and is arranged above the top wall 60.

The transport element 76 has a magnetic element 79. The magnetic element 79 is arranged on the plate-shaped portion 77 on the side thereof facing the side wall 59.

With respect to the side wall 59, the magnetic elements 72, 79 lie directly opposite one another in order to enable a magnetic coupling of the drive element 70 and the transport element 76 to one another. In this way, the transport element 76 can also be moved during a movement of the belt 67. The transport element 76 moves along the outer circumference of the side wall 59.

The magnetic elements 72, 79 are preferably designed as Halbach arrays.

The transport element 76 also comprises rollers 80 for rolling on the housing 57. On the underside, rollers 80 are arranged for engaging in a groove-shaped recess 81 on a portion of the bottom wall 58. Rollers 80, which abut the side wall 59, are arranged on the top side.

The transport elements 76 can be detached from the housing 57 by overcoming the magnetic force, for example, for maintenance and/or cleaning purposes. It is conceivable that the transport elements 76 be format parts.

The respective holding element 51 is preferably detachably connected to a transport element 76 (FIGS. 4 and 5). The holding element 51 can preferably be detachably fixed to the connecting portion 78. In particular, a positive-locking and/or force-locking connection is conceivable, wherein a projection 82 of the holding element 51 engages in a corresponding receptacle 83 on the connecting portion 78.

The holding element 51 is arranged at least with a holding portion forming the container receptacle 52, and, in the present exemplary embodiment, overall, in relation to the direction of gravity 69, above the top wall 60. In this way, the container receptacles 52 are offset radially inwards with respect to the side wall 59.

The holding element 51 has a main body 84 from which the projection 82 protrudes. The present two container receptacles 52 are arranged on the main body 84 per holding element 51. The container receptacles 52 are positioned one behind the other in relation to the running direction of the belt 67.

The container receptacle 52 comprises a substantially semicircular recess 85 with a radially outward-pointing insertion opening 86 for the container 12. Additionally, the container receptacle 52 comprises a receptacle bottom 87, which is formed as a projection of the main body 84 and on which the container 12 can be set down.

Containers 12 can in particular be inserted laterally in the radial direction via the insertion opening 86 into the container receptacle 52 and can be removed therefrom in the opposite direction. A movement in the height direction can be provided, but is not absolutely necessary.

The holding elements 51 are positioned such that axes 88 defined by the container receptacles 52 lie in the plane 68 of the belts 67. The axis 88 coincides with an axis defined by the container 12, when the container 12 is positioned in the container receptacle 52 as intended. During the circulating movement of the containers 12, such an alignment relative to the belts 67 proves to be advantageous—in particular, in the region of curved deflection regions.

The holding elements 51 can advantageously cover a specified format range.

The transport apparatus 22 advantageously comprises different types of format sets 89 (shown schematically in FIG. 2), wherein each format set 89 comprises different types of holding elements 51, wherein the holding elements 51 of different format sets 89 differ from one another in at least one container-specific property, for example, depending upon the container type and/or upon the container size.

Depending upon which containers 12 are to be transported with the transport apparatus 22, the best-suited format set 89 can be selected, and its holding elements 51 can be connected to the transport elements 76.

As can be seen in particular in FIGS. 1 to 3 and 7, the transport apparatus 22 has a substantially triangular contour in plan view along the height direction, preferably with regard to a compact design. In this case, the contour is in particular defined by the shape of the housing 57. The components of the transport apparatus 22 are adapted to the triangular shape. The contour in particular has the shape of an isosceles right triangle.

The transport apparatus 22 comprises a first side 90 and a second side 91 aligned at an angle thereto. The sides 90, 91 enclose an angle of 90° in the present case; they form, in a manner of speaking, the legs of the triangular contour.

In addition, the transport apparatus 22 comprises a third side 92, which is aligned at an angle to each of the sides 90, 91. The respective angle is 45° in the present case. The third side 92, in a manner of speaking, forms the hypotenuse of the triangular contour.

The transport apparatus 22 comprises transfer regions 93, 94, wherein the transfer region 93 is arranged on the first side 90 and forms a take-over region 95. The transfer region 94 is arranged on the second side 91 and forms a hand-over region 96 for the containers 12.

In accordance with the present disclosure, at least one transfer region 93, 94 is designed to extend in a straight line in the running direction of the drive body 53. In the present example, both transfer regions 93, 94 extend in a straight line. In particular, it is provided that the hand-over region 96 be aligned parallel to the transport path 29. In the region of the hand-over region 96, the belt 67 runs along the transport direction 30. As a result, at the hand-over region 96, the holding elements 51 move along the transport direction 30.

A deflection region 97 is arranged between the transfer regions 93, 94 in the running direction of the belt 67; deflection regions 97 are likewise present, following the transfer region 94 and the transfer region 93 in the running direction of the belt 67. A region 98 extending in a straight line is provided on the third side 92.

Due to the deflection regions 97, the aforementioned triangular shape of the contour of the transport apparatus 22 is provided with rounded corners (FIG. 2; deviating therefrom, the schematic representation in accordance with FIG. 1 does not show any rounding).

In the present case, the coupling wheel 47 is arranged on the take-over region 95. During operation of the transport apparatus 22, containers 12 are continuously supplied via the coupling wheel 47 and are taken over by the holding elements 51, which are preferably moved at a constant speed in the region of the take-over region 95.

The belts 67 are driven such that containers 12 supplied at the take-over region are continuously received in the holding elements 51. If the holding elements 51 assigned to a belt 67 are occupied, the holding elements 51 assigned to the next belt 67 are filled, while the first-mentioned holding elements 51 are transported to the hand-over region 96.

When all holding elements 51 are occupied by containers 12, the belt 67 can preferably be accelerated in order to achieve the highest possible processing rate.

The transport apparatus 22 preferably comprises a guide element 99, which extends from the take-over region 95 via the deflection region 97 up to the hand-over region 96 and guides the containers 12 opposite the recess 85 (FIG. 2).

Via the holding elements 51, the containers 12 are moved up to the hand-over region 96. The clock rate of the transport apparatus 22 is synchronized with the clock rate of the further transport apparatus 26. The transport unit 31 receiving the containers 12 is positioned along the transport direction 30 such that the container receptacles 34 are aligned relative to the container receptacles 52 and are, for example, positioned opposite them.

The gripping elements 33 are brought from the distant position to the close position by moving along the transfer direction 35, wherein the container receptacles 34 are widened. Subsequently, the gripping elements are applied to the containers 12 via the movement of the holding parts 32 relative to one another, and the containers 12 are gripped by the gripping elements 33.

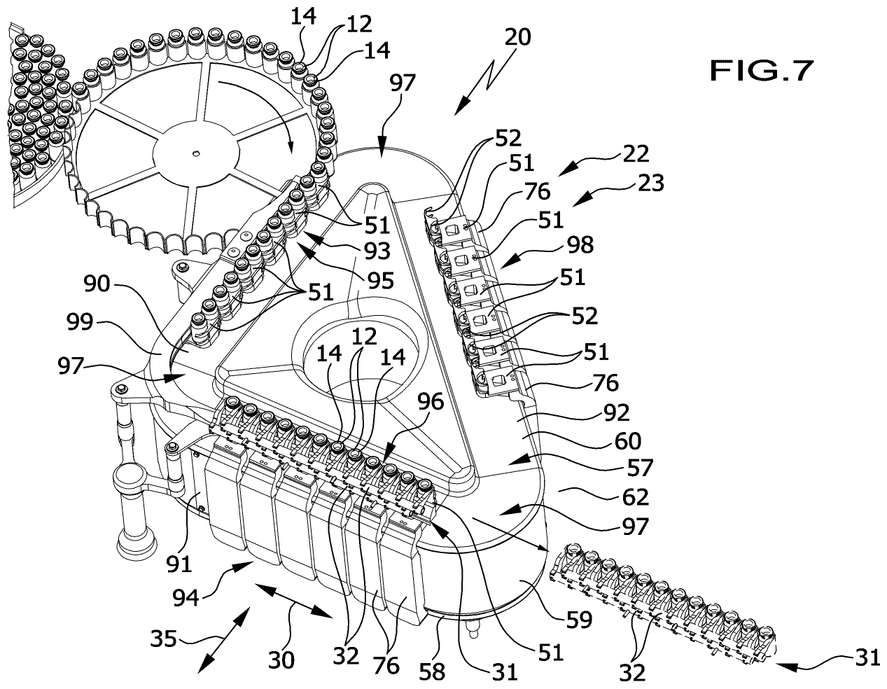

The transport unit 31 is moved along the transport direction 30. At the same time, the belt 67 is moved synchronously and parallel to the transport unit 31. During further movement of the belt 67, the holding elements 51 are moved via the following deflection region 97 away from the transport unit 31, which carries the held containers 12 (FIG. 7).

Because the containers 12 are already held by the gripping elements 33 during this movement, a guide element for the containers 12 can be omitted at the hand-over region 96.

The further movement of the belt 67 can, for example, be accelerated up to the take-over region 95 with a higher speed in view of a high processing rate.

FIGS. 2 and 7 show the respective hand-over of all containers 12 from the holding elements 51 to the transport unit 31. It can be provided that not all locations of the holding elements 51 be freed of the containers 12 via the transport unit 31. This can, for example, be implemented by a suitable relative positioning of the transport unit 31 along the transport direction 30. In this case, only as many locations of the transport unit 31 are occupied as are approached oppositely at the holding elements 51.

It is understood that the numbers of locations of the holding elements 51 assigned to a belt 67 and of the transport unit 31 could be different.

The movement explained in detail above is performed by each of the drive bodies 53 and the holding elements 51 assigned thereto. As shown in FIGS. 2 and 7, the movements of the three belts 67 are synchronized such that they preferably move at identical clock rates, which are, however, phase-shifted relative to one another. FIGS. 2 and 7 show a “snapshot,” in which the respective holding elements 51 are arranged on the first side 90, the second side 91, and the third side 92.

In the present case, the transport unit 31 moves at three times the clock rate, wherein it takes over all twelve containers 12 each time.

The transport apparatus 22 makes it possible, in particular, to continuously couple supplied containers 12 into the clocked transport apparatus 26.

The transport apparatus 24 makes it possible, in particular, to continuously decouple containers 12 from the clocked transport apparatus 26.

At the decoupling transport apparatus 24, the container transfer proceeds as follows: The containers 12 are supplied via the transport unit 31, taken over by the transport apparatus 24 at a take-over region 95, and are continuously handed over from said transport apparatus to the decoupling wheel 49 at a hand-over region 96.

It can be provided that the control of the drive device 54 takes place depending upon a signal supplied to the control device 28. For example, one of the processing stations 39 and/or a sensor device 100 of the control device 28 can transmit a signal regarding the current state. On the basis thereof, the distance-time profile for moving the holding elements 51 can, in particular, preferably be adapted during ongoing operation. Conceivable is, for example, a deceleration of the movement of the holding elements 51 in a slowing-down of the processing machine 10 downstream in the processing direction or, alternatively, an acceleration of the holding elements 51 if there is no reason for a slowdown.

FIG. 11 shows a holding element 51 for containers 12 in the form of syringes 16. For example, the holding element 51 is part of a format set 89 which is used when processing syringes 16 with the processing machine 10.

The holding element 51 also comprises two container receptacles 52. Each container receptacle 52 is formed by two holding members 101 spaced apart from one another in a height direction. Via the finger flange, the syringes 16 lie on the top side of the upper holding member 101 and engage in recesses 85 on each of the holding members 101. The holding members 101 are connected to the main body 84 via a connecting member 102.

FIG. 10 shows holding parts 32 of a transport unit 31 and gripping elements 103, which are designed in particular for gripping syringes 16. The shape and functionality of the gripping elements 103 is described in the patent application with the title, “Gripping Device for Gripping a Container and Holding Device with a Gripping Device”, of the same applicant with the same filing date, Jan. 28, 2022 (application number DE 10 2022 102 012.6), the disclosure of which is incorporated in its entirety into the present patent application.

During the hand-over of the syringes 16 from the transport apparatus 22 to the transport unit 31, the gripping elements 103 are moved in the transfer direction 35 to the close position. Subsequently, the gripping elements 103 are applied to the syringes 16, which are held on the holding members 101. Subsequently, the gripping elements 103 are moved in the transfer direction 35 to the distant position. Only thereafter is the transport unit 31 moved along the transport direction 30.

The opposite applies to the hand-over of the syringes 16 from the transport unit 31 to the transport apparatus 24.

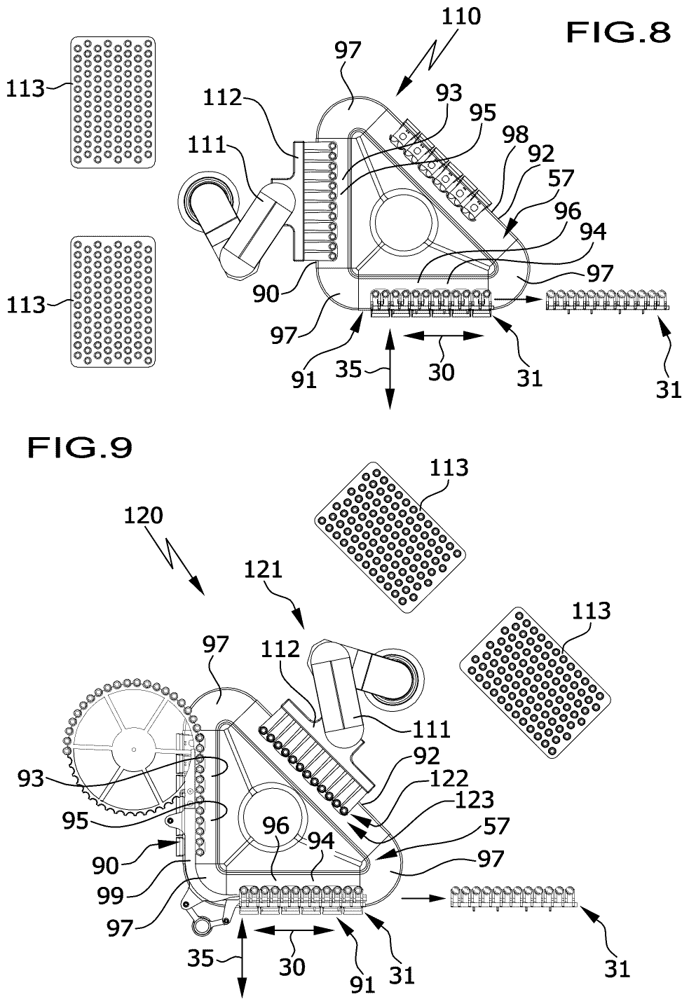

FIGS. 8 and 9 show advantageous embodiments of the transport apparatus in accordance with the present disclosure, which embodiments are denoted by reference numerals 110 and 120 and can, for example, be used instead of the transport apparatus 22 in the transport system 20. In a corresponding manner, symmetrically constructed transport apparatuses can be used on the outlet side in the transport system 20 instead of the transport apparatus 24.

Identical reference numerals are used for identical or identically acting features and components of the transport apparatuses 22, 110, and 120. Only the major differences will be discussed.

In the transport apparatus 110, the coupling unit 45 comprises a robot 111, which is, for example, designed as an articulated arm robot (Scara). The robot 111 has a holding tool 112 for the containers 12.

In this exemplary embodiment, the containers 12 are supplied by receiving the containers 12 in a common carrier 113, for example, a nest.

The robot 111 removes the containers 12 from the carrier 113 and supplies them to the transport apparatus 110. At the take-over region 95, the containers 12 are inserted via the holding tool 112 into the holding elements 51 moving in a clocked manner. For this purpose, it can be provided that the movement of the belt 67 be interrupted during the take-over of the containers 12. The further transport of the containers 12 takes place as described above.

A corresponding robot 111 can be arranged on the outlet side at a hand-over region 96 of the decoupling apparatus 25.

The transport apparatus 120 in accordance with FIG. 9 combines the functionalities of the transport apparatuses 22 and 110. Provided here is, in particular, the coupling unit 45 with the coupling wheel 47 for continuous coupling as described above.

In addition, a further coupling unit 121 is provided. The latter comprises the robot 111.

Deviating from the transport apparatus 110, the transport apparatus 120 comprises on the third side 92 a further transfer region 122, which forms a take-over region 123.

The robot 111 is so arranged and the carriers 113 are supplied in such a way that containers 12 are inserted via the robot 111 at the same clock rate into the holding elements 51 arranged at the take-over region 123.

It is understood that the coupling unit 45 or the coupling unit 121 are, advantageously, selectively used in the transport apparatus 120. In this case, continuous processing of bulk goods is in particular possible, or processing of containers 12 from the carrier 113 in a clocked manner via the robot 111 is possible.

An in particular compact design of the transport apparatus in accordance with the present disclosure and of the transport system 20 and of the processing machine 10 can be achieved with high versatility via the transport apparatus 120.

It is understood that, deviating from the representation in accordance with FIG. 9, the arrangement of the coupling units 45, 121 could also be interchanged. In this case, the robot 111 would be arranged at the take-over region 95 as in the transport apparatus 110, and the coupling wheel 47 would be arranged at the take-over region 123.

A corresponding configuration can be present on the outlet side. The decoupling apparatus 25 can comprise a further hand-over region, wherein, for example, decoupling selectively takes place via the decoupling wheel 49 or a robot 111.

### LIST OF REFERENCE NUMERALS

10 Processing machine
12 Container
14 Vial
16 Syringe
18 Frame
20 Transport system
22 Transport apparatus
23 Coupling apparatus
24 Transport apparatus
25 Decoupling apparatus
26 Further transport apparatus
28 Control device
29 Transport path
30 Transport direction
31 Transport unit
32 Holding part
33 Gripping element
34 Container receptacle
35 Transfer direction
36 Drive element
37 Transport element
38 Coupling element
39 Processing station
38 Set-down station
41 Weighing station
42 Filling station
43 Set-down station
44 Closing station
45 Coupling unit
46 Decoupling unit
47 Coupling wheel
48 Turntable
49 Decoupling wheel
50 Storage
51 Holding element
52 Container receptacle
53 Drive body
54 Drive device
55 Support device
56 Structural element
57 Housing
58 Bottom wall
59 Side wall
60 Top wall
61 Interior
62 Outer wall
63 Drive shaft
64 Drive roller
65 Deflection roller
66 Tensioning roller
67 Belt
68 Plane
69 Direction of gravity
70 Drive element
71 Main body
72 Magnetic element
73 Connecting member
74 Roller
75 Recess
76 Transport element
77 Plate-shaped portion
78 Connecting portion
79 Magnetic element
80 Roller
81 Recess
82 Projection
83 Receptacle
84 Main body
85 Recess
86 Insertion opening
87 Receptacle bottom
88 Axis
89 Format set
90 First side
91 Second side
92 Third side
93 Transfer region
94 Transfer region
95 Take-over region
96 Hand-over region
97 Deflection region
98 Region
99 Guide element
100 Sensor device
101 Holding member
102 Connecting member
103 Gripping element
110 Transport apparatus
111 Robot
112 Holding tool
113 Carrier
120 Transport apparatus
12 Coupling unit
122 Transfer region
123 Take-over region

1. A transport apparatus for pharmaceutical containers comprising:
a drive body, which is a closed circulating drive body;
a drive device, controllable by a control device, for implementing a clocked movement of the drive body;
multiple holding elements operatively connected to the drive body, each holding element having at least one container receptacle for receiving a respective container;
in a running direction of the drive body, a first transfer region for containers, a second transfer region for containers, and a deflection region arranged between the first transfer region and the second transfer region in a circulating direction of the drive body,
the first transfer region forming a take-over region and the second transfer region forming a hand-over region,
the first transfer region and/or the second transfer region being designed to extend in a straight line relative to the running direction of the drive body.

2. The transport apparatus according to claim 1, wherein at least one of the first transfer region and the second transfer region is curved relative to the running direction of the drive body.

3. The transport apparatus according to claim 1, further comprising a first side, on which the first transfer region is arranged, and a second side, on which the second transfer region is arranged, wherein the first side and the second side are aligned at an angle to one another, and wherein the angle is in approximately 30° to 120°.

4. The transport apparatus according to claim 3, wherein the angle is 90° or 45°.

5. The transport apparatus according to claim 3, further comprising a third transfer region for containers, the third transfer region connected to the first transfer region and to the second transfer region in the running direction of the drive body via at least one deflection region in each case.

6. The transport apparatus according to claim 5, wherein at least one of the following applies:
the third transfer region forms a take-over region or a hand-over region;
the third transfer region is designed to extend in a straight line or be curved relative to the running direction of the drive body.

7. The transport apparatus according to claim 6, further comprising a third side, wherein the third transfer region is arranged on the third side, wherein the third side is aligned at an angle relative to the first side and/or to the second side, and wherein the angle is approximately 30° to 120°.

8. The transport apparatus according to claim 7, wherein the angle is 90° or 45°.

9. The transport apparatus according to claim 1, wherein the transport apparatus forms a coupling apparatus, wherein containers are couplable into at least one take-over region via at least one coupling unit and decouplable via the hand-over region to a further transport apparatus.

10. The transport apparatus according to claim 1, wherein the transport apparatus forms a decoupling apparatus, wherein containers are couplable via the take-over region from a further transport apparatus and decouplable via at least one hand-over region to at least one decoupling unit.

11. The transport apparatus according to claim 1, wherein the transport apparatus is configured to be passive for taking over and/or handing over containers, wherein a take-over by an active coupling unit, a hand-over to an active decoupling unit, and/or a take-over and/or hand-over by an active further transport apparatus take place.

12. The transport apparatus according to claim 1, wherein the transport apparatus has a substantially triangular contour in plan view.

13. The transport apparatus according to claim 12, further comprising a contour formed as an isosceles triangle, an equilateral triangle, a right triangle, or an isosceles right triangle.

14. The transport apparatus according to claim 1, wherein the transport apparatus is free of processing stations for the containers.

15. The transport apparatus according to claim 1, further comprising:
a housing that encloses an interior;
drive elements coupled to the drive body, the drive body and the drive elements being arranged in the interior;
transport elements connected to, comprising, or forming the holding elements and assigned to the drive elements, the transport elements being arranged on an outer side of the housing facing away from the interior, the transport elements being movable on the outer side via movement of the drive bodies.

16. The transport apparatus according to claim 15, wherein the drive elements are magnetically coupled to the transport elements.

17. The transport apparatus according to claim 15, wherein the housing comprises a circumferential side wall, and wherein the transport elements are movable along the side wall in a circumferential direction of the housing.

18. The transport apparatus according to claim 15, wherein the drive elements comprise rollers for rolling on a side, facing the interior, of a housing wall, and/or the transport elements comprise rollers for rolling on a side, facing away from the interior, of the housing wall, wherein the housing wall is a side wall of the housing.

19. The transport apparatus according to claim 15, wherein the housing comprises a top wall, wherein the holding elements or at least holding portions that receive containers of the holding elements are arranged above the top wall relative to a direction of gravity.

20. The transport apparatus according to claim 19, wherein the holding elements each comprise at least one container receptacle for receiving a container, the at least one container receptacle being arranged above the drive body in the direction of gravity.

21. The transport apparatus according to claim 15, wherein the holding elements are detachably connectable to the transport elements.

22. The transport apparatus according to claim 21, wherein the transport apparatus comprises format sets of different types of holding elements, wherein the holding elements of a first format set of the format sets differ from the holding elements of a second format set of the format sets in at least one container-specific property, wherein the holding elements of a format set are selectively usable with the transport apparatus, for connection to the transport elements.

23. The transport apparatus according to claim 15, wherein at least one of the following applies:
the transport elements project beyond a top wall in a height direction, wherein the holding elements are arranged above the top wall of the housing and are connected to the transport elements;
the holding elements are arranged laterally next to a side wall of the housing so that the container receptacles are arranged radially outside with respect to the side wall;
the holding elements comprise holding portions receiving the containers, which holding portions are arranged offset radially inwards relative to the side wall of the housing.

24. The transport apparatus according to claim 1, wherein the at least one container receptacle defines an axis, which runs in a plane defined by the drive body.

25. The transport apparatus according to claim 1, wherein the at least one container receptacle comprises a recess for positive-locking and/or force-locking reception of a container, and/or a receptacle bottom on which a container is settable, wherein the recess comprises an insertion opening for the container in a direction of an outer side of the transport apparatus.

26. The transport apparatus according to claim 1, wherein the holding elements each comprise two or more container receptacles for receiving two or more containers.

27. The transport apparatus according to claim 1, wherein the drive body is or comprises a belt, and wherein the drive device comprises a drive roller for the belt and a drive motor for driving the drive roller.

28. The transport apparatus according to claim 1, wherein the drive body comprises a plurality of drive bodies, with each drive body being assigned to multiple holding elements.

29. The transport apparatus according to claim 28, wherein, via the plurality of drive bodies, a continuous take-over of the containers during coupling via a coupling wheel or a continuous hand-over of the containers during decoupling via a decoupling wheel is possible, in combination with a possibility of a clocked transfer to a transport apparatus operating in a clocked manner.

30. The transport apparatus according to claim 28, further comprising respective drive devices assigned to the plurality of drive bodies, wherein, for driving the plurality of drive bodies, the drive devices are controllable independently of one another by the control device.

31. The transport apparatus according to claim 1, wherein the drive device is controllable for moving the drive body with regard to at least one of:
a distance-time profile of the drive body with regard to a clocked transport of the containers;
a time of movement of the drive body;
a standing time of the drive body without movement;
a speed of the drive body;
an acceleration of the drive body;
stopping the movement of the drive body at the take-over region and/or at the hand-over region;
the drive body passing the take-over region and/or the hand-over region without stopping.

32. The transport apparatus according to claim 31, wherein control of the drive device is changeable by the control device during operation of the transport apparatus depending upon a signal suppliable or supplied to the control device.

33. A transport system comprising:
at least one transport apparatus according to claim 1; and
at least one coupling unit located at a take-over region,
wherein the containers are configured to be taken over by the multiple holding elements from the coupling unit supplying said containers.

34. The transport system according to claim 33, wherein the at least one coupling unit comprises a coupling wheel for the containers, which are taken over as bulk goods by the transport apparatus while rotating the coupling wheel and moving the drive body.

35. The transport system according to claim 33, wherein the at least one coupling unit comprises a robot for receiving containers, which are arranged in a common carrier and are suppliable to the holding elements for take-over.

36. A transport system comprising:
at least one transport apparatus according to claim 1; and
at least one decoupling unit located at a hand-over region,
wherein the containers are configured to be handed over by the holding elements to the at least one decoupling unit.

37. The transport system according to claim 36, wherein the at least one decoupling unit comprises a decoupling wheel for the containers, which are handed over as bulk goods to the transport apparatus while rotating the decoupling wheel and moving the drive body.

38. The transport system according to claim 36, wherein the at least one decoupling unit comprises a robot, to which the containers are configured to be handed over for insertion into a common carrier.

39. A transport system comprising:
at least one transport apparatus according to claim 1; and
a further transport apparatus,
the further transport apparatus comprising a transport path extending in a straight line and defining a transport direction, and at least one transport unit arranged at the transport path so as to be movable along the transport direction,
wherein the transport unit is movable in a clocked manner under control of the control device,
wherein the transport path is aligned to an extension direction of the first transfer region or the second transfer region extending in the straight line,
wherein clocked movements of the drive body and of the transport unit are synchronizable such that at least a portion of the container receptacles of the holding elements and corresponding container receptacles of the transport unit are alignable relative to one another along the transport direction,
and wherein at least a portion of the containers are transferable from the transport apparatus to the transport unit or vice versa.

40. The transport system according to claim 39, wherein a number of respective container receptacles of the holding elements in total is equal to a number of container receptacles of the transport unit, wherein all container receptacles of the holding elements are occupied, just like all container receptacles of the transport unit, or only a portion of the containers occupying the container receptacles of the holding elements are transferred to the transport unit or vice versa.

41. The transport system according to claim 39, wherein the transport unit comprises holding parts, movable relative to one another along the transport direction, and gripping elements held thereon, wherein a gripping element on a first holding part of the holding parts, together with a gripping element on a second holding part of the holding parts, defines an expandable container receptacle in each case, and wherein the holding parts are movable transversely or perpendicularly to the transport direction in a transfer direction.

42. The transport system according to claim 41, wherein the gripping elements for transferring the containers between the transport apparatus and the transport unit are transferable along the transfer direction from a distant position to a close position in order to bring the container receptacles of the holding elements into alignment with the container receptacles of the transport unit, wherein, for hand-over to the transport unit, the containers are gripped by the gripping elements and removed from the container receptacles of the holding elements by said gripping elements, or wherein, for take-over by the transport unit, the containers are inserted by the gripping elements into the container receptacles of the holding elements.

43. The transport system according to claim 41, wherein, during transfer of the containers, the drive body is non-driven and the transport unit is not moved along the transport direction, wherein the containers are transferred between a distant position and a close position by moving the gripping elements.

44. The transport system according to claim 43, wherein, during the transfer of the containers, the holding elements are moved synchronously and in parallel to one another via the drive body and the transport unit, wherein the gripping elements assume the close position.

45. A processing machine for processing containers, the processing machine comprising:
a transport system according to claim 33; and
at least one processing station for the containers, the at least one processing station arranged at a transport path and suppliable with the containers by the at least one transport unit,
wherein the at least one processing station comprises at least one of:
a weighing station;
a filling station;
a closing station;
a monitoring station;
a parking station; and
a holding station.
